(19) United States
(12) Patent Application Publication
(10) Pub. No.: US 2007/0109314 A1
(43) Pub. Date: May 17, 2007

(54) ADAPTIVE PIXEL-BASED BLENDING METHOD AND SYSTEM

(75) Inventors: An-Te Chiu, TAIPEI (TW); Roger Lin, TAIPEI (TW); Denzel Wang, TAIPEI (TW)

Correspondence Address: LOWE HAUPTMAN BERNER, LLP, 1700 DIAGONAL ROAD, SUITE 300, ALEXANDRIA, VA, 22314, US

(73) Assignee: VIA TECHNOLOGIES, INC., TAIPEI (TW)

(21) Appl. No.: 11/459,251

(22) Filed: Jul. 21, 2006

Related U.S. Application Data
(63) Continuation-in-part of application No. 10/851,223, filed on May 24, 2004, now abandoned.
(60) Provisional application No. 60/472,732, filed on May 23, 2003.

(51) Int. Cl. G09G 5/02

(52) U.S. Cl. 345/592

(57) ABSTRACT

The present invention is a general mode of a pixel-based adaptive blending method. By receiving several different input signals to generate a pixel and a blending factor of each signal, an output pixel can be generated depending on these pixels and blending factors. Thus, several different video and graphic images can be overlapped and blended flexibly on an output display.

### CROSS REFERENCE

This application is a continuation-in-part of U.S. patent application Ser. No. 10/851,223, filed, May 24, 2004 which claims priority from Provisional Application No. 60/472,732 filed May 23, 2003, all of which are incorporated herein by reference.

### BACKGROUND OF THE INVENTION

1. Field of the Invention

The present invention generally relates to a method for overlapping between graphic and video images, and more particularly to a method and system for overlapping and adjusting blending factors of various video/graphic images.

2. Description of the Prior Art

In the frame display field of the dynamic images, the single frame buffer architecture and the dual frame buffer architecture are usually used to merge and display graphic and video images. In general, the method of deciding to alternatively display video images or graphic images in the dual frame buffer architecture is to find chroma keying by looking up a particular color entry of the color lookup table. Besides, another method of that is black detection; in this regard, using the principle that black is mostly easy to be detected and therefore takes black as one kind of chroma keying. Both of the two methods described above take the pixels of graphic images as transparency and then video images will be displayed when a particular color (for instance, chroma keying or black) in the pixel streams is detected.

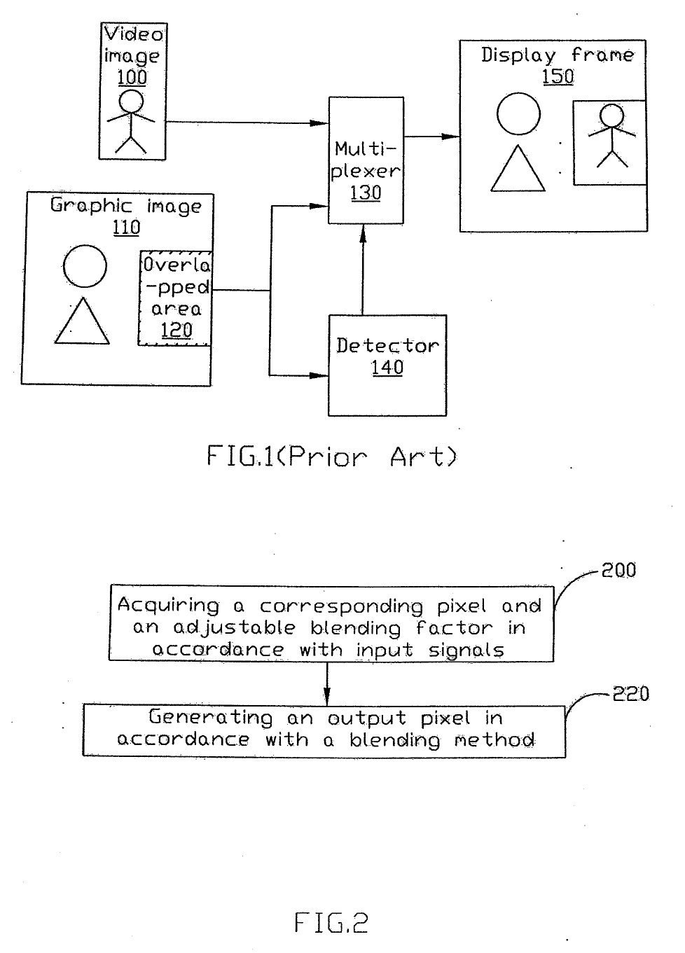

FIG. 1 depicts a conventional method for overlapping between graphic and video images. A display frame 150 is composed of a video image 100 and a graphic image 110, wherein the video image 100 and the graphic image 110 respectively send the corresponding pixels relative to the display frame 150 at the same time. The overlapped area 120 of the graphic image 110 can be filled with chroma keying, and using a detector 140 to detect whether it has chroma keying or not when the pixel streams of graphic images are sent to multiplexer 130. When the detecting result shows that it has chroma keying, and then multiplexer 130 chooses pixels of the video image 100 for output; otherwise, choosing pixels of the graphic image 110 for output.

Although we can use the method described above to make video images to be overlapped with graphic images, or blending video and graphic images with a certain blending factor for achieving an effect of transparency mix, but its flexibility is restricted. In this regard, for instance when using ¼ RGB color value of a video image and ¾ RGB color value of a graphic image as the pixels of a particular area for output, resulting in an effect of overlapping and semi-transparency, but the method with a fixed blending factor is less flexibility in the applications of dynamic images. For instance, when requiring blending of overlapped area in different ways of transparency, or producing an effect of fade-in and fade-out, the flexibility of the method described above is restricted. Besides, the prior art is usually restricted by overlapping of a graphic image and a video image or overlapping of a graphic image and a frame; moreover, when the source of the frame has various graphic images or video images, the flexibility of the above-mentioned method is restricted and not enough to the applications of dynamic images.

### SUMMARY OF THE INVENTION

The present invention provides an adaptive pixel-based blending method which includes the steps, respectively acquiring a corresponding pixel and an adjustable blending factor in accordance with a plurality of input signals; and generating an output pixel in accordance with a blending method.

The present invention also provides an adaptive pixel-based blending system which includes the means, a pixel and blending factor generating unit which is configured to respectively generate a corresponding pixel and a blending factor in accordance with a plurality of input signals; and a mixer which is configured to generate an output pixel in accordance with a blending method, the plurality of pixels and the plurality of blending factors.

Besides, the present invention provides a video-processing chip which includes the means, a blending factor generating module which is configured to respectively generate a plurality of corresponding blending factors in accordance with a plurality of input signals; and a mixer which is configured to generate an output pixel in accordance with a plurality of source pixels and the plurality of blending factors.

Accordingly, the method and system according to the embodiments of the present invention can dynamically change the blending factor of pixels by a programmable procedure in the pixels-extracting process; and it is therefore increase the flexibility and the applications of overlap between multi-input video images and graphic images.

### BRIEF DESCRIPTION OF THE DRWAING

The present invention can be best understood through the following description and accompanying drawings, wherein:

FIG. 1 schematically shows the diagram of conventional method for overlapping between graphic and video images;

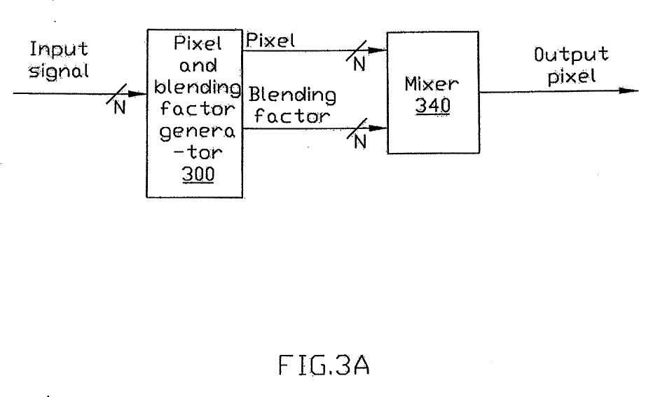

FIG. 2 schematically shows the flow chart of the adaptive pixel-based blending method according to one preferred embodiment of the present invention;

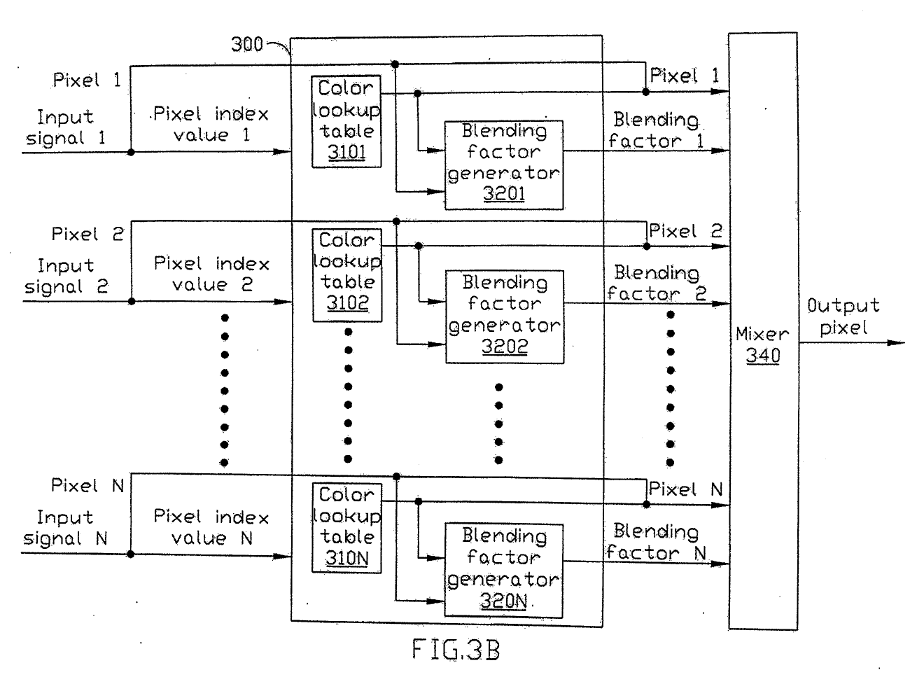

FIG. 3A schematically shows the diagram of the adaptive pixel-based blending system according to one preferred embodiment of the present invention;

FIG. 3B schematically shows the diagram of the adaptive pixel-based blending system according to another preferred embodiment of the present invention; and

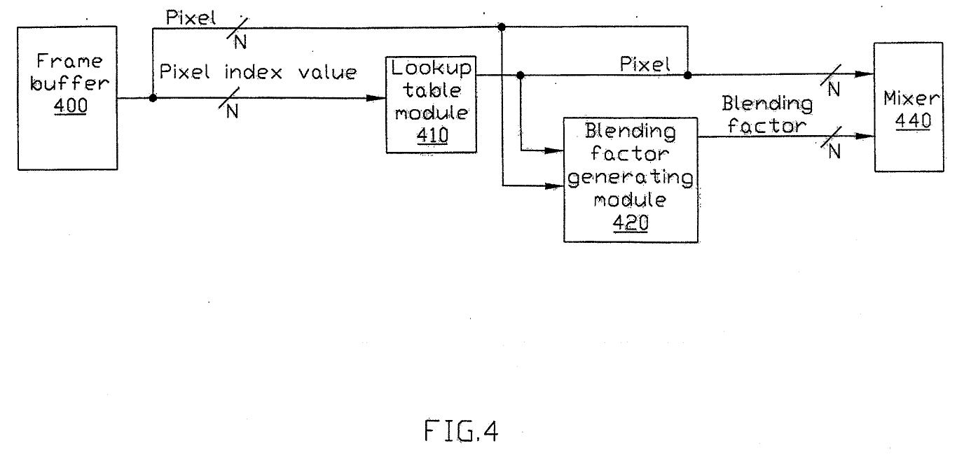

FIG. 4 schematically shows the diagram of the video-processing chip according to one preferred embodiment of the present invention.

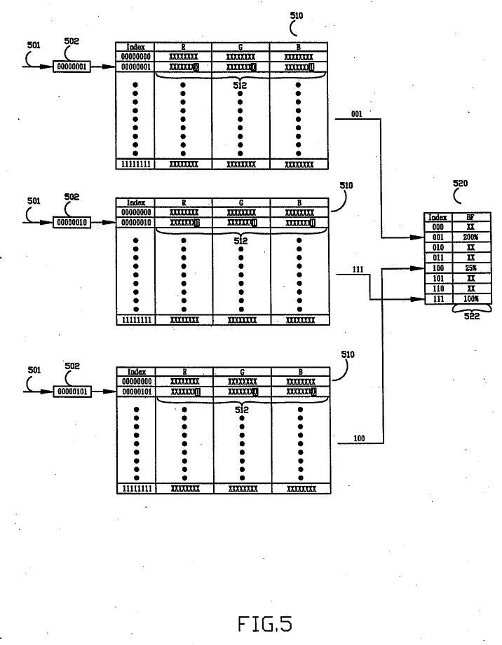

FIG. 5 illustrates an example for generating the pixels and blending factors from corresponding input signals in accordance with an embodiment of the present invention.

### DESCRIPTION OF THE PREFERRED EMBODIMENT

Some appropriate and preferred embodiments of the present invention will now be described in the following. It should be noted, however, that the embodiment is merely an example and can be variously modified without departing from the range of the present invention.

It is to be understood, however, that the drawings, which are not to scale, are designed for the purpose of illustration and not as a definition of the limits of the invention, for which reference should be made to the appended claims.

FIG. 2 schematically shows the flow chart of the adaptive pixel-based blending method according to one embodiment of the present invention. First, step 200 is respectively acquiring a corresponding pixel and an adjustable blending factor in accordance with each of a plurality of input signals. When each of the input signals is a pixel index value of indirect colors, thus the way that looking up a color lookup table can generate each pixel of them. For instance, acquiring a corresponding pixel by verifying the pixel index value with a corresponding color entry of the color lookup table, which can dynamically change the contents of that by a programmable procedure. And then, the adjustable blending factor can be formed by partial bits of the pixel value. Next, step 220 is generating an output pixel in accordance with a blending method, wherein the output pixel is generated by the blending method in accordance with the pixels of each signal and the blending factor. For instance, each of signal A, B and C respectively generates pixel 1, 2 and 3, and each pixel of them is composed of a red value (R), a green value (G) and a blue value (B). Otherwise, each pixel of them is composed of a luminance value (L) and a chrominance value (C). For instance, the values of R, G, B are respectively (50, 50, 50), (100, 100, 100) and (200, 200, 200), and each of the blending factors is respectively 200%, 100% and 25%, thus multiplying each of the pixel values by the blending factors. It is therefore that we can get each of the blending values, which is respectively (100, 100, 100), (100, 100, 100) and (50, 50, 50); moreover, adding them for obtaining an output pixel, (250, 250, 250). It should be appreciated that, each of the blending values is limited to a range, for instance, each of the blending values is restricted that not greater than a maximum color value and the output pixel is limited to being not greater than the maximum color value; otherwise, an overflow condition will occur. Further, the maximum color value represents the maximum of the pixels; for instance, the maximum color value is 255 when using in a 256-colors environment, which the color range is from 0 to 255. When the pixel is composed of various pixel values, all of the blending values and the output pixel value is restricted within the maximum color value of the output pixel value. For instance, when each of the maximum color values of the output red, green and blue value of the output pixel, is respectively 63, 31 and 63; and then each of RGB values of each blending value (generated by the pixels of all signals and the blending factors) is respectively limited to 63, 31 and 63. Furthermore, each of RGB values of the output pixel (generated by the way that adding each blending value) is also respectively limited to 63, 31 and 63.

Besides, the contents of various signals can generate the pixels with the same color values and different blending factors by dynamically changing the contents of the color entries; moreover, when the contents of various signals are invariable, it can achieve a special display effect by dynamically changing the blending factor. For instance, when the contents of a signal are A, B, C, D and E, generating the pixels (that are all color 1) by verifying the color lookup table, while the blending factors are 100%, 75%, 50%, 25% and 0% respectively; thus the pixels generated by the signal will be gradually changed from color 1 to diluted color at different timing. And finally, it generates a fade-out effect. Therefore, each of the signal sources simply sends the signal contents related with the pixels, and the same pixels with different blending factors are sent in different contents of signals; thus there is no need to send the information of both pixels and blending factors. Further, it will save the storage space and the communication cost of source signals. For instance, when each blending factor related with each pixel requires 8 bits to represent a frame with 1024×768 resolution and then each frame requires 6,291,456 bits, results in large cost of displaying 30 frames per second.

FIG. 3A schematically shows the diagram of the adaptive pixel-based blending system according to one preferred embodiment of the present invention. The system includes a pixel and blending factor generator 300, configured to respectively generate a corresponding pixel and a blending factor in accordance with a plurality of input signals; and a mixer 340, configured to generate an output pixel in accordance with a blending method, the plurality of pixels and the plurality of blending factors. And next, FIG. 3B schematically shows the diagram of the adaptive pixel-based blending system according to another preferred embodiment of the present invention. The system includes a pixel and blending factor generator 300, wherein the generator 300 further includes various programmable lookup tables 3101˜310N, configured to output corresponding pixels in accordance with a corresponding color entry of a color lookup table (which is in response to each input signal). The system further includes various blending factor generators 3201˜320N, each blending factor generator is configured to receive an input signal for generating corresponding blending factors. The blending method and other related details of the embodiment is the same as the former embodiment, and thus there is no need to give unnecessary details.

FIG. 4 schematically shows the diagram of the video-processing chip according to one preferred embodiment of the present invention. The video-processing chip includes a blending factor generating module 420, configured to respectively generate a plurality of corresponding blending factors in accordance with a plurality of input signals; and a mixer 440, configured to generate an output pixel in accordance with a plurality of source pixels and the plurality of blending factors. Further, the blending factor generating module 420 includes various blending factor generators 4201˜420N, and the video-processing chip further includes a frame buffer 440 and a color lookup table module 410. Moreover, the frame buffer 440 is configured to save the plurality of pixels of video/graphic images and provide the blending factor generating module 420 with the plurality of input signals. Furthermore, the color lookup table module 410 also includes a plurality of lookup tables 4101˜410N, each lookup table is configured to save a plurality of color entries and then be extracted by the plurality of input signals; and the contents of each color entry are pixels.

While this invention has been described with reference to illustrative embodiments, this description does not intend or construe in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

FIG. 5 illustrates an example for generating the pixels and blending factors from corresponding input signals in accordance with an embodiment of the present invention. As shown in FIG. 5, input signals 501 comprise indices 502 for a first look-up table 510 containing entries of pixel values 512 with blending information embedded in partial bits thereof. The blending information embedded in each pixel is in turn an index for a second look-up table 520 containing entries of blending factors 522. Particularly, an index to the second look-up table 520 can be reconstructed by the three least significant bits of the RGB components of the pixel. If the pixel values corresponding to input signals 501 are respectively (50,50,50), (100,100,100), and (200,200,200), for example, and the indices to the second look-up table 520 are respectively 001, 111, and 100, then the corresponding blending factors can be found to be (200%,100%,25%) through the second look-up table 520 in this example. The output pixel value for the three input signals will be generated by computing (50×200%+100×100%+200×25%, 50×200%+100×100%+200×25%, 50×200%+100×100%+200×25%) which equals to (250,250,250).

1. An adaptive pixel-based blending method, comprising:
generating respectively corresponding pixels in accordance with a plurality of input signals;
generating respectively adjustable blending factors in accordance with partial bits of said corresponding pixels; and
generating an output pixel in accordance with a blending method.

2. The method according to claim 1, wherein said blending method comprising:
calculating a product of each of said corresponding pixels and said adjustable blending factor for being a blending value; and
calculating a sum of said blending values.

3. The method according to claim 2, wherein each of said blending values is limited to a maximum color value and said output pixel is also limited to said maximum color value.

4. (canceled)

5. The method according to claim 1, further comprising:
mapping each of said plurality input signals to a corresponding color entry of a programmable lookup table, wherein one of said corresponding pixels is extracted from the content of said corresponding color entry.

6. (canceled)

7. An adaptive pixel-based blending system, comprising:
a pixel and blending factor generator, configured to respectively generate a corresponding pixel and a blending factor in accordance with each of a plurality of input signals; and
a mixer, configured to generate an output pixel in accordance with a blending method, said plurality of pixels and said plurality of blending factors,
wherein said blending factor is adjustable and is generated in accordance with partial bits of each of said corresponding pixel.

8. The system according to claim 7, wherein said mixer is configured to calculate a product of each pair of said plurality of pixels and said plurality of blending factors for being a blending value, and then calculate a sum of said blending values for generating said output pixel.

9. The system according to claim 7, wherein said pixel and blending factor generator comprising:
a plurality of programmable lookup tables, configured to output each of said corresponding pixels in accordance with each of said plurality of input signals that are in response to a color entry of said programmable lookup table.

10. The system according to claim 7, wherein said pixel and blending factor generator comprising:
a plurality of blending factor generators, each of said plurality of blending factor generators is configured to receive one of said input signals for generating said corresponding blending factor.

11. A video-processing chip, comprising:
a blending factor generating module, configured to respectively generate a plurality of corresponding blending factors in accordance with a plurality of input signals; and
a mixer, configured to generate an output pixel in accordance with a plurality of source pixels and said plurality of blending factors,
wherein said blending factor generating module is configured to generate and adjust said blending factor in accordance with partial bits of corresponding pixels generated in accordance with said plurality of input signals.

12. The chip according to claim 11, further comprising:
a lookup table module which comprises a plurality of lookup tables, each of said lookup tables is configured to save a plurality of color entries and then being extracted by said plurality of input signals, and the content of each of said color entries is said pixel.

13. (canceled)

14. The chip according to claim 11, further comprising:
a frame buffer, configured to save said corresponding pixels of said plurality of video/graphic images for providing said plurality of input signals.

15. The chip according to claim 12, wherein said input signal is an index value of said lookup table when using in an indirect color mode.

16. The chip according to claim 14, wherein said input signal is an index value of said lookup table when using in an indirect color mode.
